(19) United States
(12) Patent Application Publication
(10) Pub. No.: US 2022/0413440 A1
(43) Pub. Date: Dec. 29, 2022

(54) ADDITIONAL TIME ZONE DISPLAY MODULE

(71) Applicant: ETA SA Manufacture Horlogère Suisse, Grenchen (CH)

(72) Inventor: Stefan Rombach, Bienne (CH)

(73) Assignee: ETA SA Manufacture Horlogère Suisse, Grenchen (CH)

(21) Appl. No.: 17/830,920

(22) Filed: Jun. 2, 2022

(30) Foreign Application Priority Data
Jun. 23, 2021 (EP) 21181108.8

(51) Int. Cl. G04B 19/22

(52) U.S. Cl. CPC G04B 19/223

(57) ABSTRACT

A display module (100) for displaying at least two time zones. The display module (100) includes at least one date wheel (110), at least one main wheel (120) and at least one movable intermediate wheel (130). The at least one date wheel (110) is configured to displace said at least one movable intermediate wheel (130) into at least one first position (101) and to drive the at least one main wheel (120) via the at least one movable intermediate wheel (130). The at least one main wheel (120) is configured to displace the at least one movable intermediate wheel (130) into at least one second position (102) so as to disengage the at least one movable intermediate wheel (130) from the at least one date wheel (110) and to correct the time of the at least one second time zone.

### CROSS-REFERENCE TO RELATED APPLICATION

This application claims priority to European Patent Application No. 21181108.8 filed Jun. 23, 2021, the entire contents of which are incorporated herein by reference.

### TECHNICAL FIELD OF THE INVENTION

The field of the present invention relates to that of watches with a dual display, more specifically the field of the present invention relates to that of watches with an additional time zone display.

### TECHNOLOGICAL BACKGROUND

Different mechanisms are known in the prior art to allow two different time zones to be displayed.

However, the mechanism for integrating the display of a time zone is often complex and requires the development of a horological movement dedicated to displaying this function or significant modifications to an existing horological movement for the integration thereof in a modular manner.

### SUMMARY OF THE INVENTION

The invention relates to an additional time zone display module for a horological movement; said horological movement comprising at least one date wheel configured to drive at least one date disc; said display module comprising at least:
One main wheel; said at least one main wheel being configured to indicate a second time of at least one second time zone; and,
One movable intermediate wheel; said at least one movable intermediate wheel being configured to be displaced between at least one first position and at least one second position;
said at least one date wheel being configured to displace said at least one movable intermediate wheel into said at least one first position and to drive said at least one main wheel via said at least one movable intermediate wheel, and
said at least one main wheel being configured to displace said at least one movable intermediate wheel into said at least one second position so as to disengage said at least one movable intermediate wheel from said at least one date wheel and to correct said time of said at least one second time zone.

Thanks to this arrangement, the display of an additional time zone can be integrated without any major modifications to an existing horological movement.

According to one embodiment, said at least one movable intermediate wheel comprises at least one movable element configured to be displaced between said at least one first position and said at least one second position, and at least one movable intermediate wheel disposed on said at least one movable element.

According to one embodiment, said at least one movable element comprises at least one return element configured to displace said at least one movable element from said at least one second position into said at least one first position.

According to one embodiment, said at least one movable element comprises at least one banking and at least one guide member configured to guide said at least one movable element between said at least one first position and said at least one second position; said at least one guide member abutting against said at least one banking in said at least one first position and in said at least one second position.

Thanks to any of the above provisions, the time of said at least one second time zone can be corrected.

The invention relates to a horological movement configured to receive at least one display module according to the invention and comprising at least one date wheel configured to drive at least one date disc and configured to displace said at least one movable intermediate wheel into said at least one first position so as to drive said at least one main wheel.

The invention relates to a timepiece comprising at least one horological mechanism according to the invention.

### BRIEF DESCRIPTION OF THE FIGURES

The invention will be described in more detail hereafter using the accompanying drawings, given by way of examples that are in no way limiting, wherein:

FIGS. 1A and 1B show the driving and correction of the time of said at least one second time zone;

FIG. 2 shows an additional time zone display module 100 for a horological movement 200 according to one embodiment; and

FIG. 3 shows a timepiece 300 comprising a horological movement 200 including an additional time zone display module 100 according to the invention.

### DETAILED DESCRIPTION OF THE INVENTION

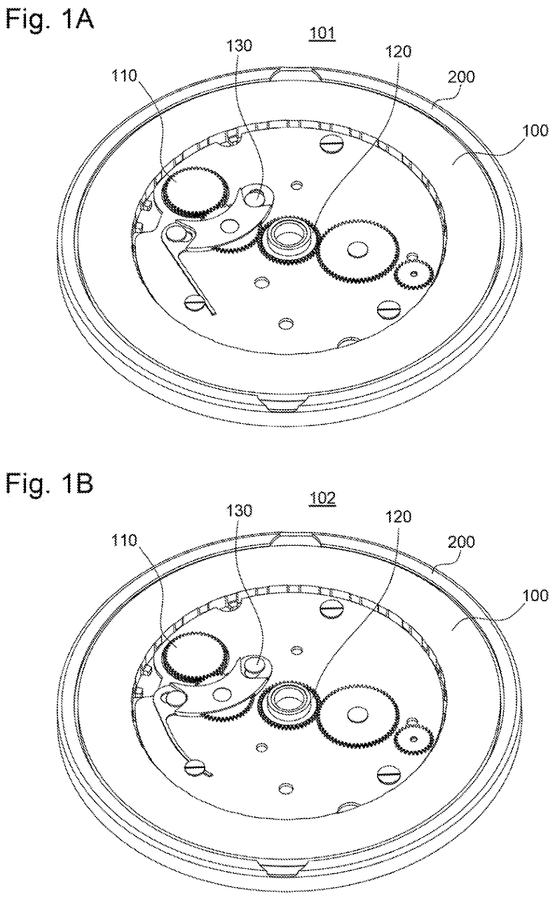

FIG. 1 shows a conventional horological movement 200 integrating an additional time zone display module 100 according to the invention.

Said horological movement 200 comprises at least one date wheel 110 configured to drive at least one date disc. Said at least one date wheel 110 is itself driven by an hour wheel (not shown) which makes one revolution every 12 hours, whereas said at least one date wheel 110 makes one complete rotation every 24 hours. In other words, the angular velocity of said at least one date wheel 110 is twice as low as that of said hour wheel.

As can be seen in FIGS. 1A and 1B, said display module 100 is integrated into said horological movement 200 and comprises at least one opening 105 configured to allow said at least one date wheel 110 to pass therethrough.

Additionally, there is at least one main wheel 120 configured to be driven by said at least one date wheel 110 so as to indicate a second time of at least one second time zone. This driving is made possible by at least one movable intermediate wheel 130 disposed between said at least one date wheel 110 and said at least one main wheel 120.

Said at least one movable intermediate wheel 130 can be displaced between at least one first position 101 and at least one second position 102. More specifically, when said at least one date wheel 110 rotates in a first direction, i.e. in a direction allowing the date disc to be incremented by one date, said at least one movable intermediate wheel 130 is displaced into said at least one first position 101 and thus transmits the rotation of said at least one date wheel 110 to said at least one main wheel 120, as shown in FIG. 1A. Given that said at least one date wheel 110 and said at least one main wheel 120 perform one rotation every 24 hours, said at least one main wheel 120 can indicate at least one second time zone in 24 hours.

However, as shown in FIG. 1B, when said time of said at least one second time zone must be corrected by a setting system, said at least one main wheel 120 displaces said at least one movable intermediate wheel 130 into said at least one second position 102 and thereby disengages said at least one movable intermediate wheel 130 from said at least one date wheel 110.

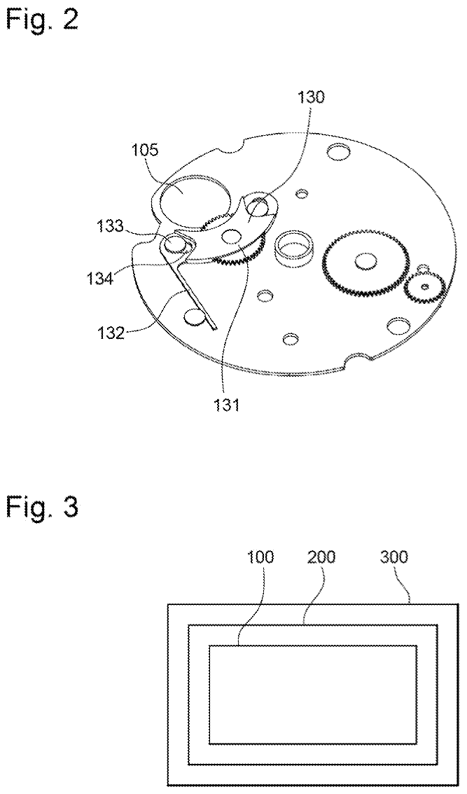

As shown in FIG. 2, said at least one movable intermediate wheel 130 comprises at least one movable element 131 configured to be displaced between said at least one first position 101 and said at least one second position 102, and at least one movable intermediate wheel 130 disposed on said at least one movable element 131. Said at least one movable element 131 comprises at least one return element 132 configured to displace said at least one movable element 131 between said at least one second position 102 and said at least one first position 101. According to certain embodiments (not shown), said at least one movable element 131 can further provide for said at least one movable element 131 moving between said at least one second position 102 and said at least one first position 101.

The displacement of said at least one movable intermediate wheel 130 is conditioned by at least one banking 133 and at least one guide member 134 comprised by said at least one movable element 131.

Said at least one guide member 134 allows said at least one movable element 131 to be guided between said at least one first position 101, FIG. 1A, and said at least one second position 102, FIG. 1B.

In said at least one first position 101 and at least one second position 102, said at least one guide member 134 abuts against said at least one banking 133 so as to limit the movement of said at least one movable intermediate wheel 130.

1. An additional time zone display module (100) for a horological movement (200); said horological movement (200) comprising at least one date wheel (110) configured to drive at least one date disc; said display module (100) comprising at least:
one main wheel (120); said at least one main wheel (120) being configured to indicate a second time of at least one second time zone; and
one movable intermediate wheel (130); said at least one movable intermediate wheel (130) being configured to be displaced between at least one first position (101) and at least one second position (102);
said at least one date wheel (110) being configured to displace said at least one movable intermediate wheel (130) into said at least one first position (101) and to drive said at least one main wheel (120) via said at least one movable intermediate wheel (130), and
said at least one main wheel (120) being configured to displace said at least one movable intermediate wheel (130) into said at least one second position (102) so as to disengage said at least one movable intermediate wheel (130) from said at least one date wheel (110) and to correct said time of said at least one second time zone.

2. The display module (100) according to claim 1, wherein said at least one movable intermediate wheel (130) comprises at least one movable element (131) configured to be displaced between said at least one first position (101) and said at least one second position (102), and at least one movable intermediate wheel (130) disposed on said at least one movable element (131).

3. The display module (100) according to claim 2, wherein said at least one movable element (131) comprises at least one return element (132) configured to displace said at least one movable element (131) between said at least one second position (102) and said at least one first position (101).

4. The display module (100) according to claim 2, which comprises said at least one movable element (131) comprising at least one banking (133) and at least one guide member (134) configured to guide said at least one movable element (131) between said at least one first position (101) and said at least one second position (102); said at least one guide member (134) abutting against said at least one banking (133) in said at least one first position (101) and in said at least one second position (102).

5. The display module (100) according to claim 2, which comprises at least one unidirectional correction mechanism; said at least one unidirectional correction mechanism comprising a wheel set configured to cause said at least one main wheel (120) to rotate so as to correct said time of said at least one second time zone and to displace said at least one movable intermediate wheel (130) into said at least one second position (102) so as to disengage said at least one movable intermediate wheel (130) from said at least one date wheel (110).

6. A horological movement (200) configured to receive at least one display module according to claim 1 and comprising at least one date wheel (110) configured to drive at least one date disc and configured to displace said at least one movable intermediate wheel (130) into said at least one first position (101) so as to drive said at least one main wheel (120).

7. A timepiece comprising at least one horological mechanism according to claim 6.
